(19) United States
(12) Patent Application Publication
(10) Pub. No.: US 2002/0133463 A1
(43) Pub. Date: Sep. 19, 2002

(54) Method for reporting characteristics of a service provider such as an application service provider

(75) Inventors: Dan Edward Curtis, Hingham, MA (US); Doreen Lynn Galli, Marietta, GA (US); Chrystine Marie Raheb, Matawan, NJ (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/810,629

(22) Filed: Mar. 16, 2001

(51) Int. Cl. G06F 17/60

(52) U.S. Cl. 705/50; 705/26

(57) ABSTRACT

A management service gathers information regarding the performance of a service provider (SP) such as an application service provider (ASP) or an Internet Service Provider (ISP). The management service analyzes the information gathered, generates a report, and provides the report to at least two clients of the SP. In one embodiment of the invention, the information gathered is performance information. In another embodiment, the information gathered is availability information. In yet another embodiment, the information gathered is security information. Information may be gathered by electronic monitoring, or by human enquiry, or by any other research technique appropriate to the task at hand. The report may be provided to the client as hard copy or as soft copy or in person orally.

### FIELD OF THE INVENTION

The present invention is related to the field of service providers, and more specifically to advising clients of a service provider such as an application service provider or an Internet service provider regarding characteristics of the service provider.

### BACKGROUND

A business enterprise may improve its efficiency by focusing its efforts and resources on the core activities of the business, and outsourcing other activities. In response, application service providers (ASP) have arisen. ASPs provide computer-application services to their clients. Often, these services are based upon the Internet and the World Wide Web. For example, an ASP might provide web-based services that accept purchase orders from customers on behalf of a retailer, and relay these orders to the retailer.

In such situations, the client would like to have information about the characteristics of the ASP, for example information regarding the ASP's performance, availability, security, and so forth. Although the client could in principle rely on information provided by the ASP itself, it is natural for the client to prefer a more impartial view. If the client were to generate such information on its own, the client would again confront the disadvantages of venturing outside its business core, and incur the attendant economic inefficiency.

Given the complexity of modem technology, this is more than a theoretical concern. Thus, there is a need for an impartial and economically efficient way of providing information on the characteristics of an ASP to a client of the ASP. Given the similar complexity of Internet service itself, the same need applies as well to clients of Internet Service Providers (ISPs), and to clients of other kinds of telecommunication-based service providers.

### SUMMARY OF THE INVENTION

In response to the foregoing need, the present invention teaches an impartial and economically efficient way to provide information about the characteristics of a service provider such as an Application Service Provider (ASP) or an Internet Service Provider (ISP) to clients of the service provider.

According to the present invention, a third-party management service gathers information about characteristics of the service provider, analyzes this information, generates a report based on the outcome of the analysis, and provides the report to more than one client of the service provider.

According to one embodiment of the present invention, the management service gathers information regarding the performance of a service provider such as an ASP, ISP, or other service provider. According to another embodiment of the present invention, the management service gathers information regarding the availability of the service provider. In yet another embodiment of the present invention, the management service gathers information regarding the security of the service provider. In the foregoing embodiments and in other embodiments of the present invention, information may be gathered by electronic monitoring, or by human enquiry, or by any other research technique appropriate to the task at hand. Further, the report may be delivered to the client as hard copy, as soft copy, or orally in person by a representative of the management service. As those skilled in the art will appreciate, the present invention may be embodied as a method, an apparatus, a system, or a computer program product, and further that the invention applies to many kinds of service providers including but not limited to ASPs and ISPs.

These and other aspects of the present invention will be more fully appreciated when considered in light of the following detailed description and drawings.

### BRIEF DESCRIPTION OF THE DRAWINGS

FIG. 1 shows the relationship of the service provider, the management service, and the clients, according to the present invention.

FIG. 2 shows the operation of the management service according to the present invention.

### DETAILED DESCRIPTION OF THE INVENTION

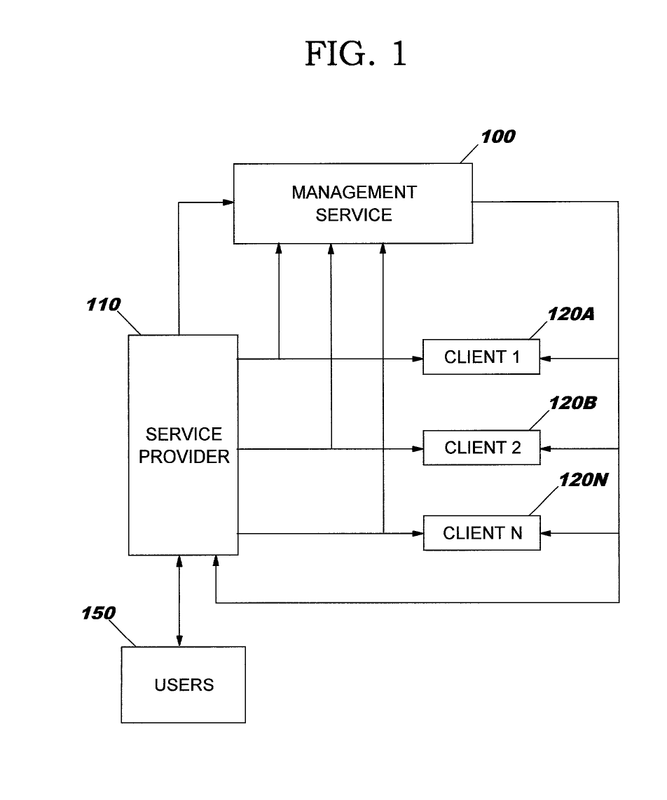

FIG. 1 shows a structure illustrating the relationship of the Service Provider (SP), the management service, and the clients according to one aspect of the present invention. As shown in FIG. 1, a management service 100 gathers information about the characteristics of a service provider (SP) 110. The SP 110 may interact with N clients 120A through 120N, where N is at least 2, or may interact with a population of users 150 such as a population of shoppers engaged in retail shopping, or may interact with a combination of clients 120A through 120N and users 150.

The information gathered by the management service 100 may include information about the performance, availability, or security of the SP 110.

Performance information may concern the responsiveness of the Service Provider (SP) 110. In an illustrative embodiment of the present invention, performance information about responsiveness of an Application Service Provider (ASP) is characterized statistically by a mean value and a probability density function or cumulative distribution function that describe the time between (a) receipt by the ASP of an incoming request to the ASP and (b) an outgoing response from the ASP. The request may come from a member of the user population 150 or from a client 120A through 120N. Performance information may also concern the integrity with which the Service Provider (SP) 110 delivers data to a client 120A through 120N or to a member of the user population 150. Integrity may be measured by a bit-error rate, a frame-error rate, a count of errored seconds, or by other such measures as would be known to those skilled in the art.

Availability information may concern the susceptibility of the Service Provider (SP) 110 to failure. Failure may be measured by minutes-of-time-per-month when the SP 110 is unable to respond within a predetermined interval, for example three seconds, to an incoming request from a client 120A through 120N or from a member of the user population 150. Often, such failure may be attributed to the temporary inoperability of hardware or software as commonly known to those skilled in the art as “downtime,” or to outages in electricity provided by power mains causing the inoperability of the SP 110, or by overload or congestion within the SP 110 or within communications facilities caused by inadequate provision of a resource such as processor power or bandwidth.

Security information may concern the vulnerability of the Service Provider (SP) 110 to attacks by unauthorized parties seeking to steal information from the SP 110 or to vandalize the SP 110. This information may be characterized subjectively, or may be described statistically by a count or other measure of such attacks that result in adverse consequences to the SP 110, or in adverse consequences to one or more clients 120A through 120N, or in adverse consequences to a member of the user population 150, over a given period of time.

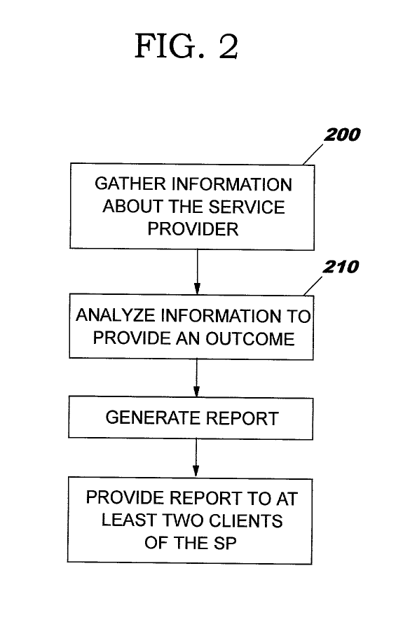

As shown in FIG. 2, the management service 100 gathers information about the Service Provider (SP) 110 as described above (step 200). Periodically or upon request, the management service 100 analyzes the information it has gathered about the SP 110 (step 210) to provide an outcome. The analysis may be objective, resulting in an outcome that is statistical, numerical, or otherwise quantitative, or may be subjective, resulting an outcome that is not quantitative, for example a discussion in prose, or the analysis and outcome may have both objective and subjective aspects.

Based on the outcome of the analysis, the management service 100 generates a report (step 220). In exemplary embodiments of the present invention, the report may comprise text or figures written on paper in the fashion commonly known as hard copy, text or figures conveyed electronically or held in electronic storage in the fashion commonly known as soft copy, or in knowledge held by a representative of the management service 100. The report is then provided by electronic transmission, which may include web and pervasive delivery, by carrier delivery such as a mail or postal service, or by in-person oral presentation to two or more of the clients 120A through 120N (step 230). The providing of the report to the two or more clients may be spread over time, i.e., none of the provisions need be simultaneous.

Further, the report may be sold directly in and of itself, or may be included as part of larger agreements between the management service 100 and the clients 120A through 120N. The report may also be sold to the Service Provider 110, and also to clients of a direct client 120A through 120N, and so forth, i.e., sale of the report is not limited to the direct clients 120A through 120N of the Service Provider 110. Further, the present invention envisions and encompasses a number of payment plans, including one-time payment, subscriptions or annuities with or without onetime payment to cover fixed costs, payment based on transactions, tiered payment based on transactions, and so forth.

From the foregoing description, those skilled in the art will appreciate that the present invention efficiently and economically provides clients 120A through 120N with information about the Service Provider (SP) 110, as the present invention enables the management service 100 to have a core business of studying the SP 110 and to share the cost of the study over at least two clients 120A through 120N of the SP 110. The foregoing description, however, is illustrative rather than limiting, and the scope of present invention is limited only by the following claims.

We claim:

1. A method for characterizing a service provider, comprising the acts of:
a) gathering information on characteristics of a service provider;
b) analyzing the information to provide an outcome;
c) generating a report responsive to the outcome; and
d) providing the report to at least two clients of the service provider;
wherein the acts of analyzing, generating, and providing are performed by a management service.

2. The method of claim 1, wherein the service provider is an ASP.

3. The method of claim 1, wherein the service provider is an ISP.

4. The method of claim 1, wherein the act of providing comprises the act of selling the report.

5. The method of claim 1, wherein the report comprises hard copy.

6. The method of claim 1, wherein the report comprises soft copy.

7. A method for a management service to advise a client of an application service provider regarding the performance of the application service provider, comprising the acts of:
a) gathering information on performance of an application service provider;
b) analyzing the information to provide an outcome;
c) generating a report responsive to the outcome; and
d) providing the report to at least two clients of the application service provider;
wherein the acts of analyzing, generating, and providing are performed by a management service.

8. The method of claim 7, wherein the act of providing comprises the act of selling the report.

9. The method of claim 7, wherein the report comprises hard copy.

10. The method of claim 7, wherein the report comprises soft copy.

11. A method for a management service to advise a client of an application service provider regarding the security of the application service provider, comprising the acts of:
a) gathering information on security of an application service provider;
b) analyzing the information to provide an outcome;
c) generating a report responsive to the outcome; and
d) providing the report to at least two clients of the application service provider;
wherein the acts of analyzing, generating, and providing are performed by a management service.

12. The method of claim 11, wherein the act of providing comprises the act of selling the report.

13. The method of claim 11, wherein the report comprises hard copy.

14. The method of claim 11, wherein the report comprises soft copy.

15. A method for a management service to advise a client of an application service provider regarding the availability of the application service provider, comprising the acts of:
a) gathering information on availability of an application service provider;
b) analyzing the information to provide an outcome;
c) generating a report responsive to the outcome; and
d) providing the report to at least two clients of the application service provider;
wherein the acts of analyzing, generating, and providing are performed by a management service.

16. The method of claim 15, wherein the step of providing comprises the act of selling the report.

17. The method of claim 15, wherein the report comprises hard copy.

18. The method of claim 15, wherein the report comprises soft copy.

19. A method for a management service to advise a client of an Internet service provider regarding the performance of the Internet service provider, comprising the acts of:
a) gathering information on performance of an Internet service provider;
b) analyzing the information to provide an outcome;
c) generating a report responsive to the outcome; and
d) providing the report to at least two clients of the Internet service provider;
wherein the acts of analyzing, generating, and providing are performed by a management service.

20. The method of claim 19, wherein the act of providing comprises the act of selling the report.

21. The method of claim 19, wherein the report comprises hard copy.

22. The method of claim 19, wherein the report comprises soft copy.

23. A method for a management service to advise a client of an Internet service provider regarding the security of the Internet service provider, comprising the acts of:
a) gathering information on security of an Internet service provider;
b) analyzing the information to provide an outcome;
c) generating a report responsive to the outcome; and
d) providing the report to at least two clients of the Internet service provider;
wherein the acts of analyzing, generating, and providing are performed by a management service.

24. The method of claim 23, wherein the act of providing comprises the act of selling the report.

25. The method of claim 23, wherein the report comprises hard copy.

26. The method of claim 23, wherein the report comprises soft copy.

27. A method for a management service to advise a client of an Internet service provider regarding the availability of the Internet service provider, comprising the acts of:
a) gathering information on availability of an Internet service provider;
b) analyzing the information to provide an outcome;
c) generating a report responsive to the outcome; and
d) providing the report to at least two clients of the Internet service provider;
wherein the acts of analyzing, generating, and providing are performed by a management service.

28. The method of claim 27, wherein the step of providing comprises the act of selling the report.

29. The method of claim 27, wherein the report comprises hard copy.

30. The method of claim 27, wherein the report comprises soft copy.
